(19) United States
(12) Patent Application Publication
(10) Pub. No.: US 2025/0272802 A1
(43) Pub. Date: Aug. 28, 2025

(54) Systems and Methods for Generating Simulated Motion from Static Images Using Machine Learning

(71) Applicants: David Lampert, Los Angeles, CA (US); Saurabh Kanwar, Los Angeles, CA (US); Craig Ward, Los Angeles, CA (US)

(72) Inventors: David Lampert, Los Angeles, CA (US); Saurabh Kanwar, Los Angeles, CA (US); Craig Ward, Los Angeles, CA (US)

(21) Appl. No.: 18/900,536

(22) Filed: Sep. 27, 2024

Related U.S. Application Data
(63) Continuation-in-part of application No. 18/584,362, filed on Feb. 22, 2024, now Pat. No. 12,105,927.

(51) Int. Cl. G06T 5/70; G06F 3/14; G06T 5/50; G06T 7/11

(52) U.S. Cl. CPC G06T 5/70; G06F 3/14; G06T 5/50; G06T 7/11; G06T 2207/20081; G06T 2207/20084; G06T 2207/20104; G06T 2207/20221

(57) ABSTRACT

A system and method for enhancing static photographs to simulate motion using machine learning models. The system comprises one or more processors and a non-transitory computer readable medium storing instructions that, when executed, cause the system to receive a static photograph, apply a machine learning model to generate a sequence of modified images creating an illusion of motion, and display the sequence to simulate a moving video. The machine learning model, trained on a dataset of static photographs and corresponding video sequences, extracts features using a convolutional neural network, processes the features with a recurrent neural network to generate motion vectors, and applies the vectors to create the modified images. The simulated motion may include tilting, vibrating, shaking, zooming, panning, and rotating. A user interface allows specifying the desired type or intensity of motion. The method enables creating video-like effects from static images, enhancing expressiveness and engagement of visual media.

### BACKGROUND

### Field of the Invention

The present invention relates generally to the field of digital image processing and computer graphics. More specifically, the invention pertains to systems and methods for enhancing static photographs to create an illusion of motion, simulating the appearance of a moving video derived from a single still image.

### Description of the Related Art

Static photographs have long been used to capture and preserve moments in time. However, despite advances in digital photography and image processing, photographs remain limited in their ability to convey a sense of motion and dynamism compared to video recordings. Existing techniques for animating still images, such as cinemagraphs or live photos, typically require specialized capture devices or manual editing, limiting their accessibility and versatility.

In the field of computer vision and machine learning, deep neural networks have shown remarkable progress in tasks such as object recognition, semantic segmentation, and style transfer. Convolutional neural networks (CNNs) have excelled at learning hierarchical features from image data, while recurrent neural networks (RNNs) are well-suited for modeling sequential information and temporal dependencies. However, the application of deep learning to create realistic video sequences from static images remains an open challenge.

One related area of research is video frame interpolation, which aims to synthesize intermediate frames between two given frames to create smooth video transitions. Methods in this domain often rely on optical flow estimation and frame warping, but struggle with handling large motions and complex deformations. Another relevant approach is video texture synthesis, which generates infinitely looping video clips from a small input sample. However, these methods typically require a video input and have limited ability to control the specific motions and transformations applied.

In the domain of 3D computer graphics, techniques such as image-based rendering and view synthesis have been used to create novel views of a scene from a set of input images. These approaches often involve estimating scene geometry and camera positions, and then rendering new views using techniques like texture mapping and image warping. However, they typically require multiple input images captured from different viewpoints and have limited ability to generate dynamic motion effects.

As such, there remains a need for systems and methods that can automatically enhance static photographs with realistic motion effects, without requiring specialized capture devices, manual editing, or extensive input data. The present invention addresses this need by leveraging deep learning techniques to learn a mapping between static images and simulated video sequences, enabling the creation of compelling video-like effects from a single still photograph.

### BRIEF SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

The present invention provides systems and methods for enhancing the display of static photographs to create the appearance of a moving video. In one embodiment, a system includes one or more processors and a non-transitory computer readable medium storing instructions. When executed by the processors, the instructions cause the system to receive a static photograph, apply a machine learning model to generate a sequence of modified images that create an illusion of motion, and display the sequence of modified images to simulate a moving video derived from the static photograph.

The machine learning model is trained on a dataset of static photographs and corresponding video sequences to learn a mapping between static images and simulated motion. Applying the model to the input photograph involves extracting features using a convolutional neural network, processing the features with a recurrent neural network to generate motion vectors, and applying the motion vectors to create the sequence of modified images. The modifications can include tilting, vibrating, shaking, zooming, panning, and rotating.

In certain embodiments, the system includes a user interface for receiving input specifying the desired type or intensity of motion to be simulated. The simulated motion can be synchronized with playback of an associated voice message to enhance the delivery of the message. In 3D environments, the static photograph can be displayed as an interactive element, allowing users to transition between the static and animated versions.

The present invention also provides a computer-implemented method for creating video-like effects from static images. The method involves receiving a static photograph, processing it with a machine learning model to generate a series of transformed images with reduced blurriness, and displaying the transformed images in sequence to create a simulated video effect.

Other aspects of the invention include applying style transfer models to generate stylized versions of the animated images, retraining the machine learning model on updated datasets to improve its performance over time, and integrating the system with mobile applications and 3D environments for capturing and displaying user-generated content.

By enabling the creation of realistic video-like effects from static photographs, the present invention enhances the expressiveness and engagement of visual media, opening up new possibilities for communication, storytelling, and creative expression.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates an exemplary system environment for simulating motion from a static photograph, according to one embodiment.

FIG. 2 illustrates an embodiment of a user interface for the system.

FIG. 3 illustrates an embodiment of the process for simulating motion from a static photograph using the system environment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

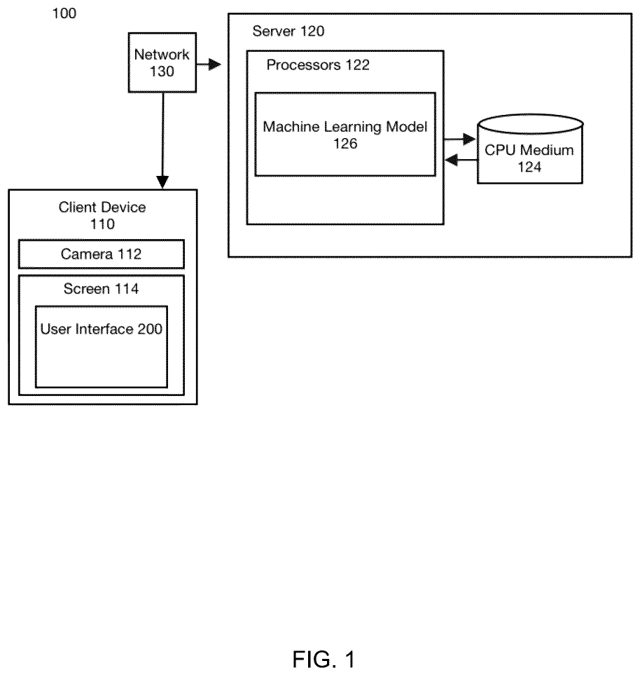

FIG. 1 illustrates an exemplary system environment 100 for simulating motion from a static photograph, according to one embodiment. The system environment 100 includes a client device 110 equipped with a camera 112 for capturing a static photograph and a screen 114 for displaying a user interface 200. The system environment 100 further comprises a server 120 having one or more processors 122, memory 124, and a machine learning model 126, wherein the client device 110 and the server 120 are configured to communicate over a network 130. The client device 110 may include, but is not limited to, personal computers, laptops, smartphones, tablets, or any other computing devices.

In the illustrated embodiment, the instructions, when executed by the one or more processors 122, cause the system 100 to perform the following operations. The server 120 is configured to receive the static photograph from the client device 110 via the network 130 and apply the machine learning model 126 to the received static photograph to generate a sequence of modified images that create an illusion of motion. The machine learning model 126 is trained to perform image analysis to reduce blurriness and artifacts between the modified images.

In one embodiment, the machine learning model 126 may be trained using a dataset comprising static photographs and corresponding moving video sequences. Applying the machine learning model 126 to the static photograph may involve segmenting the static photograph into a plurality of image regions, generating modified versions of each image region to simulate motion, and combining the modified image regions to generate each modified image in the sequence. The machine learning model 126 may comprise a convolutional neural network architecture that is optimized for video frame synthesis and artifact reduction.

In some embodiments, the server 120 may be further configured to analyze the static photograph to detect a primary subject and generate the sequence of modified images to simulate motion of the detected primary subject while keeping a background of the static photograph substantially static. Additionally, the server 120 may be configured to receive a target video clip to be simulated from the client device 110 and train the machine learning model 126 to generate the sequence of modified images to mimic the motion of the target video clip.

In certain embodiments, the server 120 may be configured to receive a user selection of a motion style to be applied from the client device 110 and apply the machine learning model 126 according to the selected motion style to generate the sequence of modified images. The motion style may be selected from a set of predefined options, including but not limited to pan, zoom, tilt, shake, vibrate, and rotate. Processing the static photograph using the machine learning model 126 may further involve generating modified images that tilt, vibrate, or shake the static photograph to create the illusion of motion.

In the illustrated embodiment, the server 120 is configured to transmit the sequence of modified images to the client device 110 over the network 130. The client device 110 is configured to display, on the screen 114, via the user interface 200, the sequence of modified images to simulate the appearance of a moving video derived from the static photograph captured by the camera 112. Displaying the sequence of modified images on the client device 110 may involve looping the sequence to simulate continuous motion.

In some embodiments, the client device 110 may be a mobile device, wherein the camera 112 is a built-in camera. The server 120 may be further configured to provide user interface features to the client device 110 for specifying one or more target regions in the static photograph to which motion is to be applied. The server 120 is configured to receive a user selection of the one or more target regions from the client device 110. Generating the sequence of modified images then involves applying the machine learning model 126 to the selected regions while maintaining other regions of the static photograph substantially static.

In certain embodiments, the server 120 may be configured to apply a filtering or sorting algorithm to the sequence of modified images based on pre-selected or user-defined criteria prior to transmitting the sequence to the client device 110. The client device 110 may be configured to integrate the sequence of modified images into a three-dimensional (3D) environment, wherein the sequence is represented as an interactive element within the 3D environment.

In some embodiments, the server 120 may be further configured to receive a content feed associated with the static photograph from the client device 110. The client device 110 is then configured to display, on the screen 114, via the user interface 200, the content feed together with the sequence of modified images simulating the appearance of the moving video.

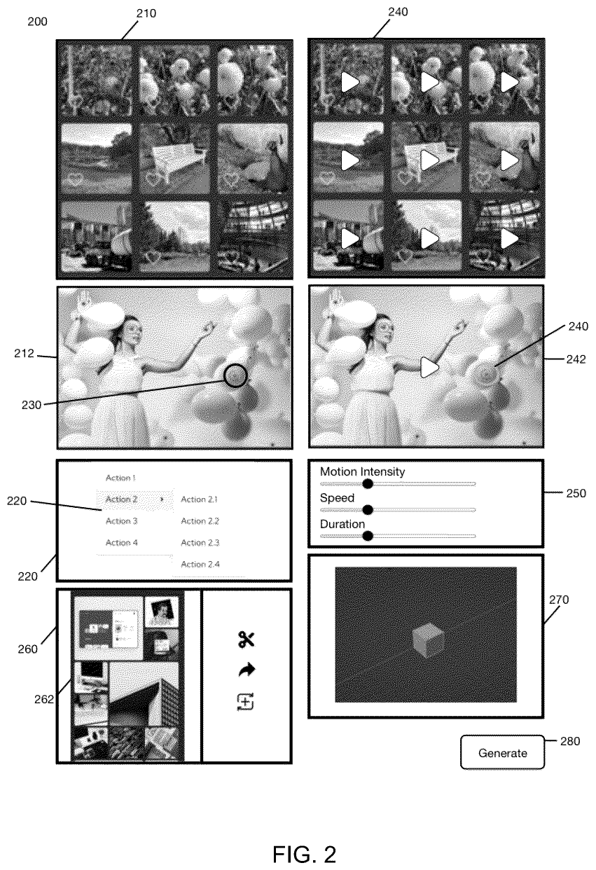

FIG. 2 illustrates an embodiment of a user interface 200 for the system 100 described in FIG. 1, wherein the user interface 200 is displayed on the screen 114 of the client device 110 and is configured to enable user interaction with the system 100 for enhancing static photographs to create the appearance of a moving video.

In the illustrated embodiment, the user interface 200 comprises a photograph selection interface 210, which includes a preview window 212 configured to allow users to select a static photograph captured by the camera 112 of the client device 110. Additionally, the user interface 200 features a motion style selection menu 220 with panels 222, wherein said panels 222 are configured to enable the user to choose from a variety of predefined motion styles, such as pan, zoom, tilt, shake, vibrate, and rotate, to apply to the selected photograph.

The user interface 200 further includes a target region selection tool 230, which is configured to allow users to specify regions within the selected photograph where motion should be applied. The target region selection tool 230 provides visual feedback in the preview window 212, enabling users to see the selected regions.

Moreover, the user interface 200 comprises a target video selection interface 240 with a preview window 242, wherein the target video selection interface 240 is configured to enable users to choose a video clip to simulate.

The user interface 200 also includes a processing settings panel 250, which is configured to allow users to adjust various parameters, such as motion intensity, speed, and duration, to fine-tune the appearance of the simulated moving video.

Additionally, the user interface 200 features a content feed integration panel 260 with a content window 262. The content feed integration panel 260 enables users to browse and select content from various feeds, such as social media platforms or news sources. Once the user selects the desired content, they can choose to either use the content from the feed to generate motion from the static photograph or integrate the content into their currently simulated motion picture. If the user opts to generate motion from the content feed, the system will analyze the feed using the machine learning model to create a sequence of modified images that simulate motion based on the selected content. Alternatively, if the user chooses to integrate the content into their existing simulated motion picture, the system will overlay the content as graphical elements, such as animated GIFs or remixed media, on top of the static photograph. This allows users to enhance their simulated motion pictures with relevant and engaging content from various sources.

Furthermore, the user interface 200 includes a 3D environment integration panel 270 with a preview window 272, which is configured to allow users to integrate the modified images into a 3D environment, creating a more immersive and dynamic visual experience.

The user interface 200 also comprises a generate button 280, which is configured to initiate the processing of the selected photograph by the server 120 to create the sequence of modified images that simulate a moving video.

Lastly, the user interface 200 includes a display panel (not shown), which is configured to allow users to view and control the playback of the generated simulated moving video, providing a seamless and interactive experience.

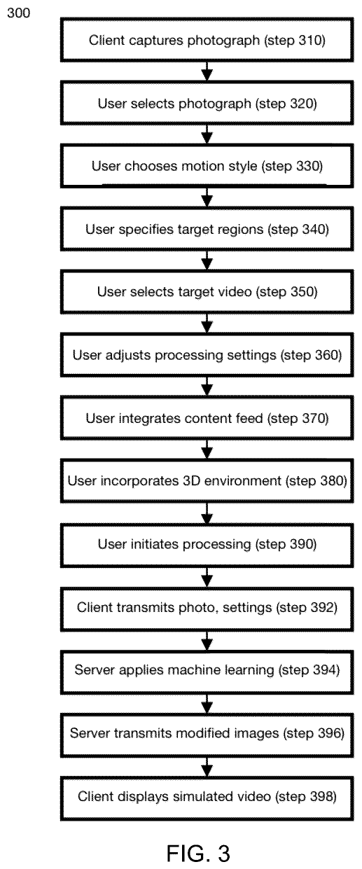

FIG. 3 illustrates an embodiment of the process 300 for simulating motion from a static photograph using the system environment 100 of FIG. 1 and the user interface 200 of FIG. 2. In the illustrated embodiment, the process 300 begins with the client device 110 capturing a static photograph using its built-in camera 112 (step 310). The user then selects the captured photograph in the photograph selection interface 210 of the user interface 200 displayed on the screen 114 of the client device 110 (step 320).

Subsequently, the user chooses a desired motion style to apply to the selected photograph using the motion style selection menu 220 in the user interface 200 (step 330). The user may select from predefined options such as pan, zoom, tilt, shake, vibrate, and rotate using the buttons 222. The user then specifies one or more target regions in the selected photograph where the chosen motion style should be applied using the target region selection tool 230 (step 340). The target region selection tool 230 is configured to provide visual feedback in the preview window 212 to guide the user's selection.

Optionally, the user may select a target video clip to simulate using the target video selection interface 240 and its preview window 242 (step 350). Additionally, the user can adjust various processing settings such as motion intensity, speed, and duration using the processing settings panel 250 in the user interface 200 (step 360).

In some embodiments, the user may choose to integrate media from a content feed associated with the selected photograph using the content feed integration panel 260 and preview the integration in the content window 262 (step 370). The user may also elect to incorporate the modified images into a 3D environment using the 3D environment integration panel 270, wherein the result can be previewed in the window 272 (step 380).

Once the user has configured the desired options, they initiate the processing of the static photograph by activating the generate button 280 in the user interface 200 (step 390). This action triggers the client device 110 to transmit the static photograph along with the user-specified settings to the server 120 over the network 130 (step 392).

Upon receiving the static photograph and settings, the server 120 applies the machine learning model 126 to analyze the photograph and generate a sequence of modified images that create an illusion of motion (step 394). The machine learning model 126, which may comprise a convolutional neural network architecture optimized for video frame synthesis and artifact reduction, is configured to perform operations including, but not limited to: segmenting the static photograph into a plurality of image regions; generating modified versions of each image region to simulate the selected motion style; applying the motion to the specified target regions while keeping other regions substantially static; combining the modified image regions to generate each modified image in the sequence; and filtering and smoothing the sequence of images to reduce blurriness and artifacts.

In some cases, the server 120 may also train the machine learning model 126 using the user-selected target video clip as a reference to mimic the desired motion. After generating the sequence of modified images, the server 120 transmits it back to the client device 110 over the network 130 (step 396).

Finally, the client device 110 displays the received sequence of modified images in the review display panel (not shown) of the user interface 200, creating a simulated moving video that provides the appearance of motion in the original static photograph (step 398). The user can view and control playback of the simulated video using the controls disposed in the display panel (not shown). In one embodiment, the client device 110 may also integrate the content feed or embed the simulated video into the selected 3D environment for an enhanced viewing experience.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A system for enhancing the display of static photographs captured by a client device to create the appearance of a moving video, comprising:
a server having one or more processors and a non-transitory computer readable medium storing instructions;
a client device having a camera for capturing a static photograph; wherein the instructions, when executed by the one or more processors, cause the system to:
receive the static photograph from the client device over a network;
apply, at the server, a machine learning model to the received static photograph to generate a sequence of modified images that create an illusion of motion, wherein the machine learning model is trained to perform image analysis to smooth blurriness and artifacts between the modified images;
transmit the sequence of modified images from the server to the client device over the network; and
display, on a screen of the client device, the sequence of modified images to simulate the appearance of a moving video derived from the static photograph captured by the camera.

2. The system of claim 1, wherein the machine learning model is trained using a dataset of static photographs and corresponding moving video sequences.

3. The system of claim 1, wherein applying the machine learning model to the static photograph comprises:
segmenting the static photograph into a plurality of image regions;
generating modified versions of each image region to simulate motion; and
combining the modified image regions to generate each modified image in the sequence.

4. The system of claim 1, wherein the machine learning model comprises a convolutional neural network architecture optimized for video frame synthesis and artifact reduction.

5. The system of claim 1, wherein the instructions further cause the system to:
analyze the static photograph to detect a primary subject; and
generate the sequence of modified images to simulate motion of the detected primary subject while keeping a background of the static photograph substantially static.

6. The system of claim 1, wherein the instructions further cause the system to:
receive, from the client device, a target video clip to be simulated; and
train the machine learning model to generate the sequence of modified images to mimic motion of the target video clip.

7. The system of claim 1, wherein the instructions further cause the system to:
receive, from the client device, a user selection of a motion style to be applied; and
apply the machine learning model according to the selected motion style to generate the sequence of modified images.

8. The system of claim 7, wherein the motion style is selected from a set of options comprising: pan, zoom, tilt, shake, vibrate, and rotate.

9. The system of claim 1, wherein displaying the sequence of modified images on the client device comprises looping the sequence to simulate continuous motion.

10. The system of claim 1, wherein the instructions further cause the system to:
transmit, to the client device, a user interface for specifying one or more target regions in the static photograph to which motion is to be applied; and
receive, from the client device, a user selection of the one or more target regions, wherein generating the sequence of modified images comprises applying the machine learning model to the selected regions while maintaining other regions of the static photograph substantially static.

11. A computer-implemented method for enhancing the display of static photographs captured by a client device to create the appearance of a moving video, the method comprising:
capturing, by a camera of a client device, a static photograph;
transmitting, by the client device, the static photograph to a server over a network; receiving, by the server, the static photograph from the client device over the network;
processing, by the server, the received static photograph using a machine learning model to generate a sequence of modified images that create an illusion of motion, wherein the machine learning model is trained to perform image analysis to smooth blurriness and artifacts between the modified images;
transmitting, by the server, the sequence of modified images to the client device over the network;
and displaying, on a screen of the client device, the sequence of modified images to simulate the appearance of a moving video derived from the static photograph captured by the camera.

12. The computer-implemented method of claim 1, wherein processing the received static photograph using the machine learning model further comprises generating modified images that tilt, vibrate, or shake the static photograph to create the illusion of motion.

13. The computer-implemented method of claim 1, wherein the machine learning model is trained using a dataset of static photographs and corresponding moving video sequences.

14. The computer-implemented method of claim 1, wherein the client device is a mobile device and the camera is a built-in camera of the mobile device.

15. The computer-implemented method of claim 1, further comprising:
receiving, by the server, a user input from the client device indicating a desired type of motion to be simulated; and
processing, by the server, the static photograph using the machine learning model to generate the sequence of modified images based on the desired type of motion indicated by the user input.

16. The computer-implemented method of claim 5, wherein the desired type of motion is selected from a group consisting of: panning, tilting, vibrating, shaking, zooming, and combinations thereof.

17. The computer-implemented method of claim 1, further comprising:
applying, by the server, a filtering or sorting algorithm to the sequence of modified images based on pre-selected or user-defined criteria prior to transmitting the sequence of modified images to the client device.

18. The computer-implemented method of claim 1, wherein displaying the sequence of modified images on the screen of the client device further comprises integrating the sequence of modified images into a three-dimensional (3D) environment, wherein the sequence of modified images is represented as an interactive element within the 3D environment.

19. The computer-implemented method of claim 8, further comprising: arranging, by the client device, a plurality of interactive elements representing different sequences of modified images in a 3D grid along X, Y, and Z axes within the 3D environment; and enabling seamless navigation through the 3D environment to view the different sequences of modified images.

20. The computer-implemented method of claim 1, further comprising: receiving, by the server, a content feed associated with the static photograph from the client device; displaying, on the screen of the client device, the content feed for the user to select from; receiving, by the server, a user selection indicating whether to: use the content from the feed to generate motion from the static photograph, or integrate the content from the feed into the currently simulated motion picture.
